(19) United States
(12) Patent Application Publication
(10) Pub. No.: US 2024/0209472 A1
(43) Pub. Date: Jun. 27, 2024

(54) SYSTEMS AND METHODS FOR THE BINDING OF RARE EARTH ELEMENTS BY BETA ROLL PEPTIDES

(71) Applicant: THE TRUSTEES OF COLUMBIA UNIVERSITY IN THE CITY OF NEW YORK, NEW YORK, NY (US)

(72) Inventors: Scott BANTA, Fairfield, CT (US); Farid KHOURY, Westlake, OH (US)

(73) Assignee: THE TRUSTEES OF COLUMBIA UNIVERSITY IN THE CITY OF NEW YORK, NEW YORK, NY (US)

(21) Appl. No.: 18/124,822

(22) Filed: Mar. 22, 2023

Related U.S. Application Data
(60) Provisional application No. 63/322,558, filed on Mar. 22, 2022.

(51) Int. Cl. C22B 3/18; C22B 59/00

(52) U.S. Cl. CPC C22B 3/18; C22B 59/00

(57) ABSTRACT

Rare earth elements (REEs) are recovered by dissolving an REE-containing source in one or more solvents. The resulting solution is contacted with block V repeats-in-toxin (RTX) domains of adenylate cyclase from Bordetella pertussis. These polypeptides are generally intrinsically disordered. However, upon binding an amount of the REEs and/or REE-containing compounds, the polypeptide folds to form a beta roll (BR) secondary structure. The polypeptides also adopt the BR structure at very low pH, e.g., below about 1.5, yet are still capable of effectively binding REEs. The metal-peptide constructs can then be isolated for recovery of REE products. Native and synthetic RTX/BR domains can be used to bind and recover REEs with higher binding capacity than lanmodulin and enhanced REE selectivity. For example, embodiments of the present disclosure can be used to extract REEs from electronic wastes such as NdFeB magnets, seaweed ashes, used during biomining and bioleaching operations, etc.

### CROSS REFERENCE TO RELATED APPLICATION(S)

This application claims the benefit of U.S. Provisional Application No. 63/322,558, filed Mar. 22, 2022, which is incorporated by reference as if disclosed herein in its entirety.

### STATEMENT REGARDING FEDERALLY SPONSORED RESEARCH OR DEVELOPMENT

This invention was made with government support under grants DE-AR0001340 awarded by the Department of Energy and 2036197 awarded by the National Science Foundation. The government has certain rights in the invention.

### BACKGROUND

Rare earth elements (REEs) can be recovered from a variety of natural and man-made sources. However, such recovery is often complicated by the relatively low concentrations of REEs in these sources, as well as the difficulty in isolating the REEs from other metals present therein. According to the U.S. Department of Energy, domestic supply of REEs has been facing shortages which could result in disruption to various technologies such as clean energy. In 2019, the U.S. generated more than six million tons of e-waste and only recycled 15%.

The lanmodulin protein has been found to bind REE ions with high specificity. However, lanmodulin, can only bind three REE ions per protein, limiting its effectiveness in binding, sequestering, and recovering REEs at industrial scales. What is desired, therefore, are methods and systems for the effective separation of REEs from a sample.

Referring now to FIG. 1, beta roll structures known for the binding of calcium are shown. The crystal structure is of alkaline phosphatase from Pseudomonas TAC II 18 (PDB 1O0Q). A model of the wild-type adenylate cyclase beta roll with sequence from B. pertussis is shown as well. In the absence of calcium, the peptide exists in a disordered conformation. In the presence of calcium, the conformation changes from disordered to a plurality of helical turns. Two repeats of the sequence make a complete helical turn and each of these turns binds a calcium atom. Therefore, the beta roll domain exhibits natural allosteric regulation. The surface-exposed residues in the folded conformation are underlined in the sequence. However, the binding of these beta roll domains have been shown to be selective, i.e., the beta roll domains are not effective at binding all metals or metal compounds, and not all metals or metal compounds are able to induce the conformational change in the beta roll.

### SUMMARY

Aspects of the present disclosure are directed to a method of recovering a metal product. In some embodiments, the method includes providing a sample including a metal component; contacting the sample with a polypeptide including at least a portion of a repeats-in-toxin (RTX) domain; and binding an amount of the metal component to the polypeptide to form a metal-peptide complex. In some embodiments, binding an amount of the metal component to the polypeptide to form a metal-peptide complex includes inducing a conformational change in the polypeptide from a disordered conformation to a beta-roll secondary structure. In some embodiments, contacting the sample with a polypeptide includes dissolving the sample to form a solution including the metal component and administering an amount of the polypeptide to the solution. In some embodiments, the method includes isolating a product including a concentration of metal-peptide complexes from the sample. In some embodiments, the method includes precipitating the metal-peptide complex from the solution. In some embodiments, the pH of the solution is below about 3. In some embodiments, the pH of the solution is below about 1.5. In some embodiments, the sample includes e-wastes, seaweed ash, mining wastes, or combinations thereof.

In some embodiments, the metal component includes rare earth elements (REEs), REE-containing compounds, or combinations thereof. In some embodiments, the metal component includes scandium, yttrium, lanthanum, cerium, praseodymium, neodymium, europium, terbium, dysprosium, ytterbium, indium, lutetium, compounds including one or more of these REEs, or combinations thereof.

In some embodiments, the polypeptide includes a plurality of oligopeptides, wherein the oligopeptides include the amino acid sequence X₁X₂X₃X₄X₅X₆X₇X₈X₉ (SEQ ID NO: 1). In some embodiments, X₁ includes glycine, valine, and serine. In some embodiments, X₂ includes glycine, serine, asparagine, or aspartic acid. In some embodiments, X₃ includes alanine, serine, glycine, aspartic acid, glutamic acid, glutamine, tyrosine, leucine, or asparagine. In some embodiments, X₄ includes glycine, arginine, or alanine. In some embodiments, X₅ includes asparagine, aspartic acid, alanine, histidine, or serine. In some embodiments, X₆ includes aspartic acid or asparagine. In some embodiments, X₇ includes threonine, isoleucine, valine, or leucine. In some embodiments, X₈ includes leucine, isoleucine, tyrosine, or phenylalanine. In some embodiments, X₉ includes tyrosine, isoleucine, leucine, valine, phenylalanine, threonine, asparagine, aspartic acid, lysine, arginine, or serine. In some embodiments, the RTX domain is from the adenylate cyclase protein of Bordetella pertussis. In some embodiments, the polypeptide includes a plurality of oligopeptide tandem repeats.

Aspects of the present disclosure are directed to a method of sequestering metals. In some embodiments, the method includes providing a bacteria modified to include one or more exogenous nucleotide sequences encoding a polypeptide, the polypeptide including at least a portion of an RTX domain; expressing the one or more exogenous nucleotide sequences to generate a concentration of polypeptides; contacting the bacteria with a medium including a metal component; and binding an amount of the metal component to the polypeptides to form a metal-peptide complex. In some embodiments, the pH of the medium is below about 1.5.

In some embodiments, the metal component includes REEs, REE-containing compounds, or combinations thereof. In some embodiments, the metal component includes scandium, yttrium, lanthanum, cerium, praseodymium, neodymium, europium, terbium, dysprosium, ytterbium, indium, lutetium, compounds including one or more of these REEs, or combinations thereof.

Aspects of the present disclosure are directed to a method of recovering REEs. In some embodiments, the method includes providing a solution including a concentration of REEs, REE-containing compounds, or combinations thereof; contacting the solution with a disordered polypeptide including at least a portion of an RTX domain; binding an amount of the REEs, REE-containing compounds, or combinations thereof to the polypeptide to form a metal-peptide complex having a beta-roll secondary structure; and isolating a product including a concentration of metal-peptide complexes from the solution. In some embodiments, the solution includes dissolved e-wastes, seaweed ash, mining wastes, or combinations thereof.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic representation of beta roll structures consistent with those used according to some embodiments of the present disclosure;

FIG. 2 is a chart of a method of recovering a metal product, such as rare earth elements (REEs), according to some embodiments of the present disclosure;

FIG. 3 is a chart of a method of sequestering metals, such as REEs, according to some embodiments of the present disclosure;

FIG. 4 is a chart of a recovering metals, such as REEs, according to some embodiments of the present disclosure;

FIGS. 5A and 5B are fluorescence resonance energy transfer (FRET) graphs showing titration of a cyan fluorescence protein (CFP), beta roll, and enhanced yellow fluorescent protein (EYFP) fusion protein with a plurality of metals;

FIG. 6 is a graph portraying the apparent disassociation constant versus the effective ionic radii for a plurality of metals, including REEs, titrated to a composition including one or more fusion proteins consistent with embodiments of the present disclosure;

FIG. 7 is a FRET graph showing titration of a CFP, beta roll, and EYFP fusion protein with of a plurality of divalent metals;

FIG. 8 shows circular dichroism (CD) spectra characterizing binding of d-block transition metals by beta roll structures;

FIG. 9 is a graph showing selective recovery of REEs over non-REE metals by purified RTX domain polypeptides;

FIG. 10A shows CD spectra characterizing binding of neodymium by beta roll structures at decreasing pH; and

FIG. 10B is a graph showing the binding capabilities of neodymium by beta roll samples at decreasing pH.

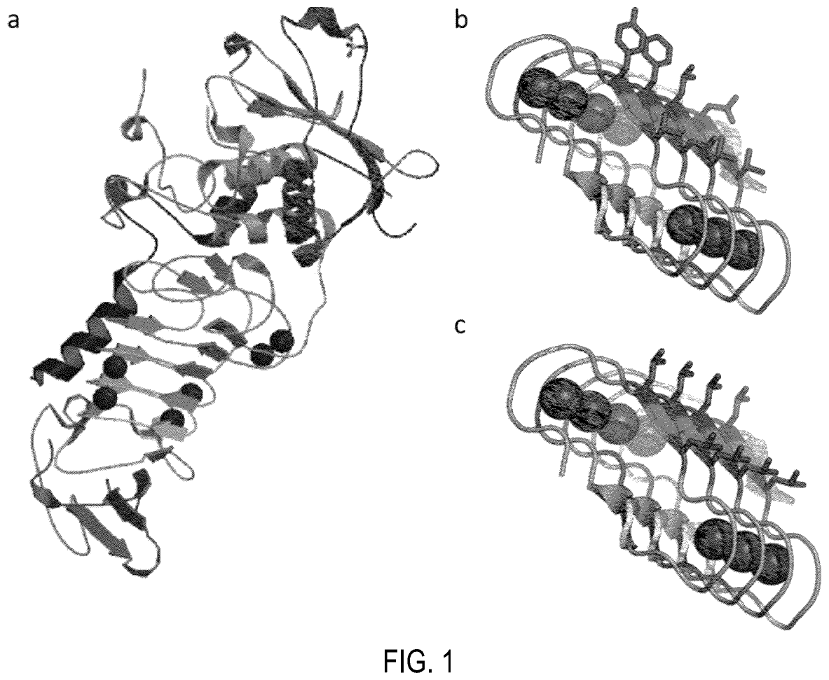

### DETAILED DESCRIPTION

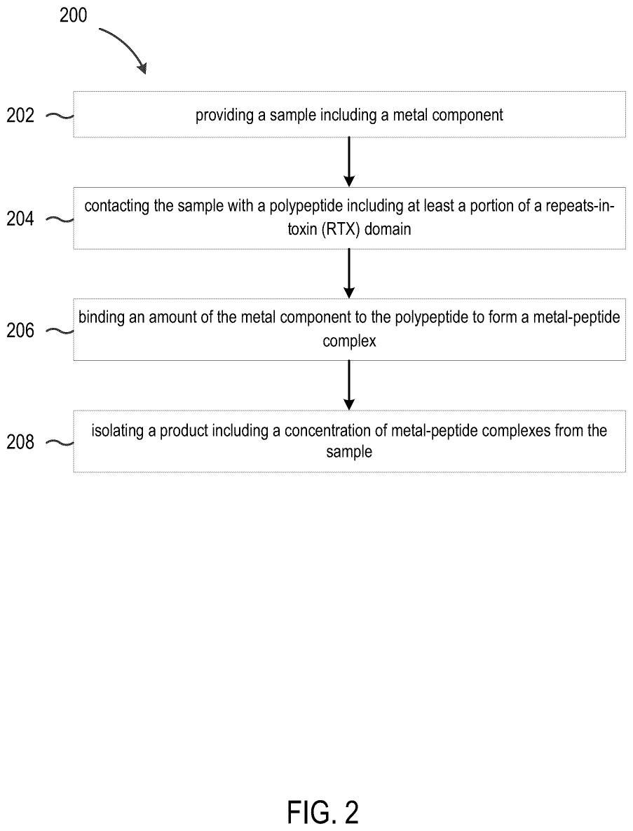

Referring now to FIG. 2, some embodiments of the present disclosure are directed to a method 200 of recovering a metal product. At 202, a sample including a metal component is provided. In some embodiments, the sample is from a natural source, man-made source, or combinations thereof. In some embodiments, the sample is sourced from one or more sources of waste. In some embodiments, the sample includes e-wastes, seaweed ash, mining wastes, or combinations thereof. In some embodiments, the e-wastes include combinations of metals, plastics, binder materials, etc., or combinations thereof. In some embodiments, the e-wastes include printed circuit boards, microchips, wiring, batteries, magnets, etc., or combinations thereof. In some embodiments, the sample is known to have a concentration of rare earth elements or suspected of having a concentration of rare earth elements.

In some embodiments, the metal component has an effective ionic radius between about 0.8 Å and about 1.1 Å. In some embodiments, the metal component is a rare earth element (REE), REE-containing compounds, or combinations thereof. In some embodiments, the REE includes scandium, yttrium, lanthanum, cerium, praseodymium, neodymium, europium, terbium, dysprosium, ytterbium, indium, lutetium, or combinations thereof. In some embodiments, the metal component is an REE-associated element, e.g., thorium.

Still referring to FIG. 2, at 204, the sample is contacted with a polypeptide including at least a portion of a repeats-in-toxin (RTX) domain. Under most conditions, RTX domains are modular repeat proteins that are intrinsically disordered. However, upon introduction of certain metal binding partners, the RTX domains can fold into a beta roll structure. Exemplary RTX sequences are repeating 9 amino acid sequences found in secreted proteins from pathogenic bacteria. Two of the repeats together form a full turn of the beta roll domain which adopts a corkscrew structure comprised of a turn followed by a short beta sheet followed by a turn.

In some embodiments, the RTX domain is from the adenylate cyclase protein of Bordetella pertussis. In an exemplary embodiment, the beta roll scaffold taken from the block V RTX domain of adenylate cyclase from Bordetella pertussis is a modular repeat protein which has been shown to be an intrinsically disordered protein that undergoes a significant conformational change upon binding calcium. This domain folds reversibly in the presence of calcium, and the domain is specific for calcium over other divalent cations. In calcium rich environments, the polypeptide forms the corkscrew-like structure with two parallel beta sheet faces separated by calcium binding turns. A C-terminal capping group responsible for entropic stabilization facilitates the calcium induced conformational response. The native capping domain confers high affinity for calcium, but other capping domains can be added which also enable calcium responsiveness. However, the multi-site calcium-binding beta roll protein has a multiple-fold higher affinity to non-calcium metals, e.g., trivalent lanthanides.

In some embodiments, the polypeptide includes a plurality of oligopeptides. In some embodiments, the oligopeptides include the amino acid sequence X₁X₂X₃X₄X₅X₆X₇X₈X₉ (SEQ ID NO: 1). In some embodiments, X₁ includes glycine, valine, and serine. In some embodiments, X₂ includes glycine, serine, asparagine, or aspartic acid. In some embodiments, X₃ includes alanine, serine, glycine, aspartic acid, glutamic acid, glutamine, tyrosine, leucine, or asparagine. In some embodiments, X₄ includes glycine, arginine, or alanine. In some embodiments, X₅ includes asparagine, aspartic acid, alanine, histidine, or serine. In some embodiments, X₆ includes aspartic acid or asparagine. In some embodiments, X₇ includes threonine, isoleucine, valine, or leucine. In some embodiments, X₈ includes leucine, isoleucine, tyrosine, or phenylalanine. In some embodiments, X₉ includes tyrosine, isoleucine, leucine, valine, phenylalanine, threonine, asparagine, aspartic acid, lysine, arginine, or serine.

In some embodiments, the polypeptide includes at least two of the oligopeptides. In certain embodiments, the polypeptide includes at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, or 20 or more of the oligopeptides. In some embodiments, the polypeptide includes a plurality of oligopeptide tandem repeats. In some embodiments, the polypeptide includes at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, or 20 or more oligopeptide tandem repeats. In some embodiments, the polypeptide includes one or more capping sequences.

In some embodiments, the oligopeptides include one or more variations relative to the sequence of SEQ ID NO: 1 so long as the variant oligopeptides retain the activity of the oligonucleotides of SEQ ID NO: 1, e.g., binding of REEs and REE-containing compounds, inducing reversible conformational change from disordered to a beta roll secondary structure upon such binding, etc. In some embodiments, changes are introduced by mutation into nucleic acid sequences, thereby leading to changes in the amino acid sequence of the oligopeptide. In some embodiments, changes are introduced by post-expression modifications to the polypeptide itself. In some embodiments, the variant oligonucleotides include one or more amino acid additions, insertions, deletions, or substitutions as compared to the sequence of SEQ ID NO: 1. By way of example, nucleotide substitutions leading to amino acid substitutions at non-essential amino acid residues can be made in the sequence of the polypeptides and/or oligopeptides. Exemplary residues which are non-essential and therefore amenable to substitution can be identified by one of ordinary skill in the art, e.g., by saturation mutagenesis, with the resultant mutants screened, to confirm conservation of the ability to bind REEs.

In some embodiments, “variant” polypeptides include one or more oligopeptides according to SEQ ID NO: 1 and one or more “variant” oligopeptides, so long as they maintain binding of REEs and REE-containing compounds, inducing reversible conformational change from disordered to a beta roll secondary structure upon such binding, etc. In some embodiments, a variant polypeptide includes an amino acid sequence having at least about 75%, 80%, 85%, 90%, 95%, 98%, or 99% identity with a non-variant amino acid sequence. In some embodiments, the polypeptides include one or more oligopeptide sequences and one or more additional fusion protein structures, e.g., sequences to aid in the purification of the polypeptides, fluorescent sequences to aid in the detection of the polypeptides, etc., or combinations thereof.

In some embodiments, the polypeptides of the present disclosure are synthesized in vitro, e.g., by solid phase polypeptide synthetic methods, recombinant DNA approaches, etc., or combinations thereof. By way of example, the beta roll peptide domains described herein can be produced as modified polypeptides, with nonpeptide moieties attached by covalent linkage to the N-terminus and/or C-terminus. In some embodiments, either the carboxy-terminus or the amino-terminus, or both, are chemically modified, e.g., acetylation and amidation of the terminal amino and carboxyl groups, respectively; amino-terminal modifications such as acylation, e.g., acetylation, or alkylation, e.g., methylation, and carboxy-terminal-modifications such as amidation, as well as other terminal modifications, including cyclization, etc.

The polypeptides can be prepared using recombinant DNA and molecular cloning techniques, e.g., in one or more bacterial hosts. In exemplary embodiments discussed in greater detail below, nucleic acid sequences encoding the polypeptides are introduced into appropriate host cells, e.g., by transformation or by transfection, and expressed.

These polypeptides can then be purified by any suitable process such as fractionation on immunoaffinity or ion-exchange columns; ethanol precipitation; reverse phase high-performance liquid chromatography (HPLC); chromatography on silica or on an anion-exchange resin such as diethylaminoethyl cellulose (DEAE); chromatofocusing; sodium dodecyl-sulfate polyacrylamide gel electrophoresis (SDS-PAGE); ammonium sulfate precipitation; gel filtration using, for example, Sephadex G-75; ligand affinity chromatography, etc., or combinations thereof.

Referring again to FIG. 2, in some embodiments, the sample is in solid or substantially solid form when contacted 204 with the polypeptide. In exemplary embodiments, the sample may be ground and provided, e.g., as a suspension or mixture in one or more liquids, to which a concentration of polypeptide is added to contact 204 the metal components therein. In these embodiments, the sample is dissolved to form a solution including the metal component. In some embodiments, an amount of the polypeptide is then administered to the solution.

In some embodiments, the contacting 204 of the sample with the polypeptides occurs in the presence of one or more acids, bases, or combinations thereof, for controlling the pH of this step. In some embodiments, the sample is contacted 204 with the polypeptides in a medium, e.g., the solution, having a pH below about 4.9. In some embodiments, the sample is contacted 204 with the polypeptides in a medium having a pH below about 3. In some embodiments, the sample is contacted 204 with the polypeptides in a medium having a pH below about 1.5.

Still referring to FIG. 2, at 206, an amount of the metal component is bound to the polypeptide to form a metal-peptide complex. In some embodiments, a plurality of metal components are bound 206 to the polypeptide. In some embodiments, the metal components are bound 206 directly to the polypeptide, i.e., no linker is disposed between the polypeptide and the metal component. In some embodiments, the polypeptides bind a plurality of the same REEs. In some embodiments, the polypeptides bind a plurality of different REEs. As discussed above, in some embodiments, binding 206 the metal components to the polypeptide, e.g., the plurality of oligopeptides, induces a conformational change in the polypeptide. In some embodiments, the conformational change is from a disordered conformation to a beta-roll secondary structure. In some embodiments, the conformational change induces precipitation of the metal-peptide complex from the solution.

At 208, a product including a concentration of metal-peptide complexes from the sample is isolated. In some embodiments, the product is isolated 208 via any suitable process, e.g., decanting, HPLC, membrane separation, etc., or combinations thereof. The metal-peptide complexes can then be recovered, e.g., as a substantially pure REE product for use in downstream processes.

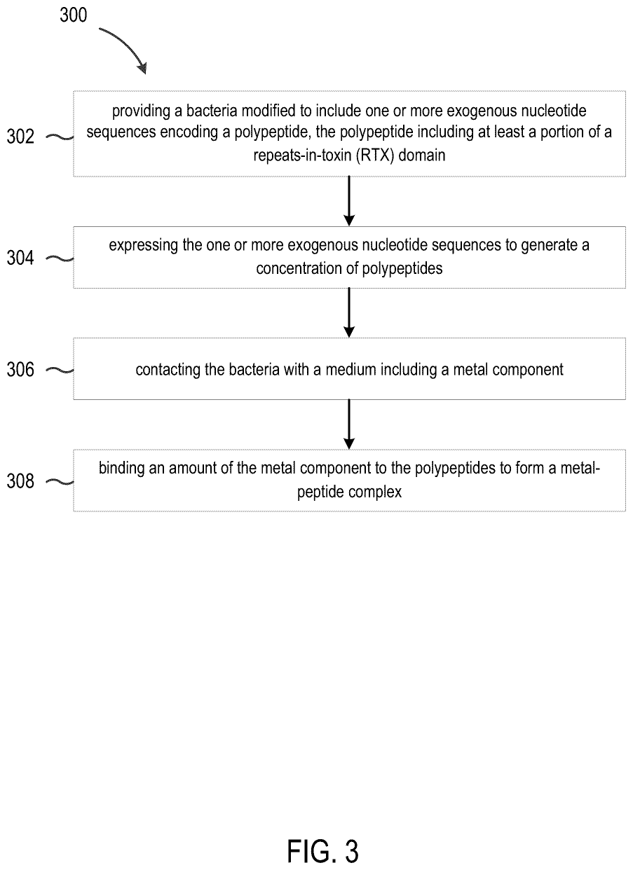

Referring now to FIG. 3, some embodiments of the present disclosure are directed to a method 300 of sequestering metals. In some embodiments, at 302, a bacteria is provided. In some embodiments, the bacteria are modified to include one or more exogenous nucleotide sequences encoding a polypeptide. As used herein, the bacteria can include a single or a plurality of bacteria, e.g., as a culture include one or more bacteria including the same modification. The polypeptides can be produced in prokaryotic or eukaryotic host cells. In some embodiments, the bacteria include E. coli, A. ferrooxidans, etc., or combinations thereof.

In some embodiments, as discussed above, the polypeptide includes at least a portion of an RTX domain. In some embodiments, the RTX domain is from the adenylate cyclase protein of Bordetella pertussis, e.g., from the block V RTX domain of adenylate cyclase.

In some embodiments, also as discussed above, the polypeptide includes a plurality of oligopeptides, variant oligopeptides, or combinations thereof. In some embodiments, the oligopeptides include the amino acid sequence X₁X₂X₃X₄X₅X₆X₇X₈X₉ (SEQ ID NO: 1). In some embodiments, X₁ includes glycine, valine, and serine. In some embodiments, X₂ includes glycine, serine, asparagine, or aspartic acid. In some embodiments, X₃ includes alanine, serine, glycine, aspartic acid, glutamic acid, glutamine, tyrosine, leucine, or asparagine. In some embodiments, X₄ includes glycine, arginine, or alanine. In some embodiments, X₅ includes asparagine, aspartic acid, alanine, histidine, or serine. In some embodiments, X₆ includes aspartic acid or asparagine. In some embodiments, X₇ includes threonine, isoleucine, valine, or leucine. In some embodiments, X₈ includes leucine, isoleucine, tyrosine, or phenylalanine. In some embodiments, X₉ includes tyrosine, isoleucine, leucine, valine, phenylalanine, threonine, asparagine, aspartic acid, lysine, arginine, or serine.

In some embodiments, the polypeptide includes at least two of the oligopeptides. In certain embodiments, the polypeptide includes at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, or 20 or more of the oligopeptides. In some embodiments, the polypeptide includes a plurality of oligopeptide tandem repeats. In some embodiments, the polypeptide includes at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, or 20 or more oligopeptide tandem repeats.

Still referring to FIG. 3, at 304, the one or more exogenous nucleotide sequences are expressed. Expression 304 of the nucleotide sequences can be executed via any suitable mechanism, e.g., natural, induced, etc., or combinations thereof. Expression 304 generates a concentration of the polypeptides. In some embodiments, the concentration of polypeptides is retained in the bacteria, excreted into the surrounding environment, or combinations thereof.

In some embodiments, at 306, the polypeptides are contacted with a sample including a metal component. In some embodiments of contacting step 306, the bacteria is contacted with a medium including the metal component. As discussed above, in some embodiments, the medium is from a natural source, man-made source, or combinations thereof. In some embodiments, the medium is sourced from one or more sources of waste. In some embodiments, the medium includes e-wastes, seaweed ash, mining wastes, or combinations thereof. In some embodiments, the e-wastes include combinations of metals, plastics, binder materials, etc., or combinations thereof. In some embodiments, the e-wastes include printed circuit boards, microchips, wiring, batteries, etc., or combinations thereof. In some embodiments, the medium is known to have a concentration of rare earth elements or suspected of having a concentration of REEs.

In some embodiments, the metal component has an effective ionic radius between about 0.8 Å and about 1.1 Å. In some embodiments, the metal component is an REE, REE-containing compound, or combinations thereof. In some embodiments, the REE includes scandium, yttrium, lanthanum, cerium, praseodymium, neodymium, europium, terbium, dysprosium, ytterbium, indium, lutetium, or combinations thereof. In some embodiments, the metal component is an REE-associated element, e.g., thorium.

In some embodiments, the medium is an in vitro bacterial culture. In some embodiments, the medium is the product of one or more industrial processes. In some embodiments, the medium is the product of one or more mining processes, i.e., the bacterial are provided in situ to a mining site. In some embodiments, the medium has a pH below about 4.9. In some embodiments, the medium has a pH below about 3. In some embodiments, the medium has a pH below about 1.5.

At 308, an amount of the metal component is bound to the polypeptides to form metal-peptide complexes. The metal-peptide complexes can then be recovered and the metal component isolated to achieve, e.g., a substantially pure REE product for use in downstream processes.

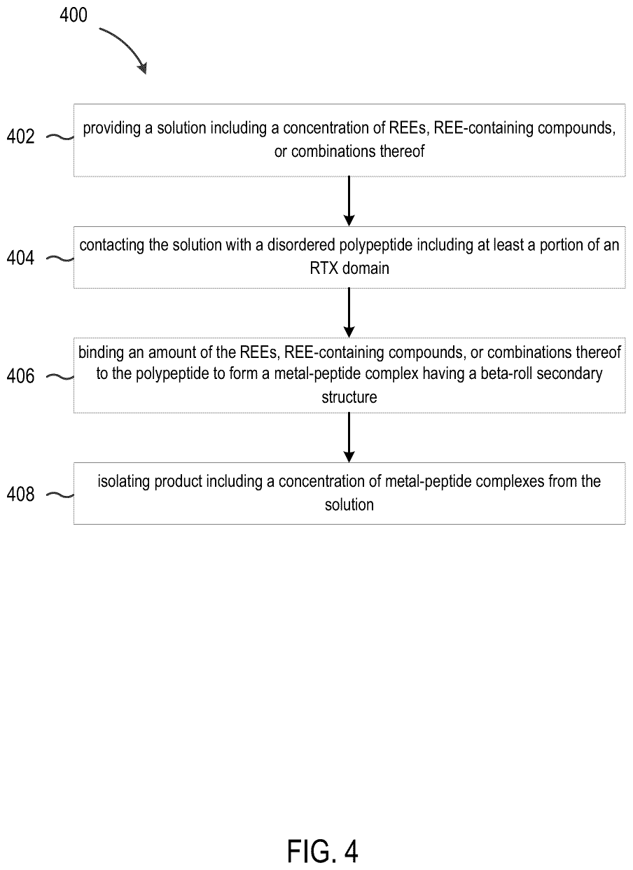

Referring now to FIG. 4, some embodiments of the present disclosure are directed to a method 400 of recovering REEs from a source thereof. As discussed above, in some embodiments, the source of the REEs includes e-wastes, seaweed ash, mining wastes, or combinations thereof. In some embodiments, the source of the REEs are solubilized to produce a solution that is then provided at 402. In these embodiments, the solution includes a concentration of REEs, REE-containing compounds, or combinations thereof.

At 404, the solution is contacted with a polypeptide including at least a portion of an RTX domain. In some embodiments, the RTX domain is from the adenylate cyclase protein of Bordetella pertussis, e.g., from the block V RTX domain of adenylate cyclase.

In some embodiments, the polypeptide includes a plurality of oligopeptides, variant oligopeptides, or combinations thereof. In some embodiments, the oligopeptides include the amino acid sequence X₁X₂X₃X₄X₅X₆X₇X₈X₉ (SEQ ID NO: 1). In some embodiments, X₁ includes glycine, valine, and serine. In some embodiments, X₂ includes glycine, serine, asparagine, or aspartic acid. In some embodiments, X₃ includes alanine, serine, glycine, aspartic acid, glutamic acid, glutamine, tyrosine, leucine, or asparagine. In some embodiments, X₄ includes glycine, arginine, or alanine. In some embodiments, X₅ includes asparagine, aspartic acid, alanine, histidine, or serine. In some embodiments, X₆ includes aspartic acid or asparagine. In some embodiments, X₇ includes threonine, isoleucine, valine, or leucine. In some embodiments, X₈ includes leucine, isoleucine, tyrosine, or phenylalanine. In some embodiments, X₉ includes tyrosine, isoleucine, leucine, valine, phenylalanine, threonine, asparagine, aspartic acid, lysine, arginine, or serine.

In some embodiments, the polypeptide includes at least two of the oligopeptides. In certain embodiments, the polypeptide includes at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, or 20 or more of the oligopeptides. In some embodiments, the polypeptide includes a plurality of oligopeptide tandem repeats. In some embodiments, the polypeptide includes at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, or 20 or more oligopeptide tandem repeats.

At 406, an amount of the REEs, REE-containing compounds, or combinations thereof are bound to the polypeptide to form metal-peptide complexes. In some embodiments, the polypeptides initially have a disordered conformation, however upon binding REEs at 406, they adopt a beta-roll secondary structure. At 408, a product including a concentration of metal-peptide complexes is isolated from the solution for use in downstream processes.

### Examples

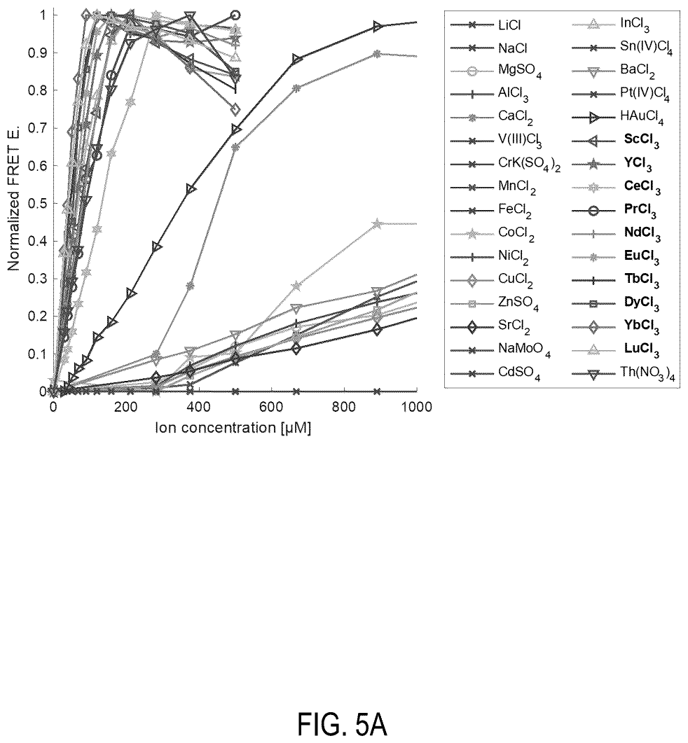

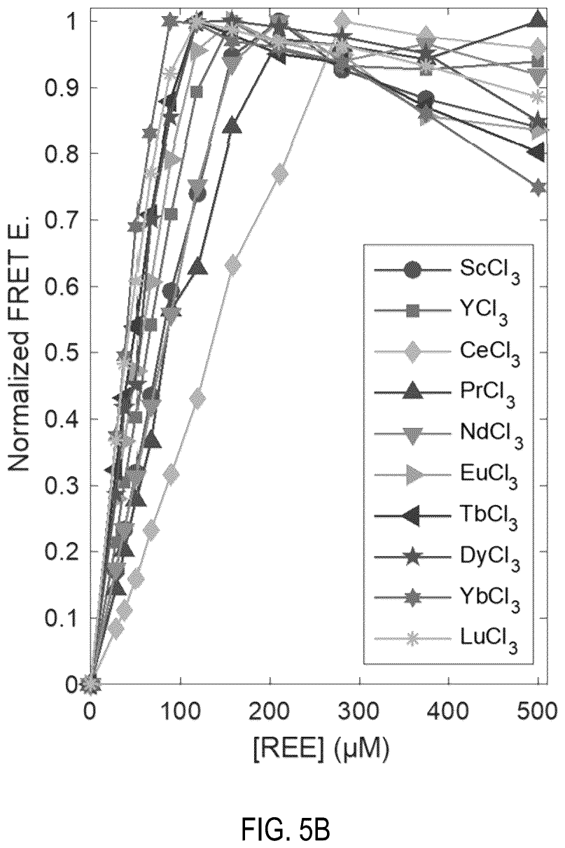

Referring now to FIGS. 5A-5B, the folding of intrinsically disordered beta roll (BR) polypeptides according to embodiments of the present disclosure was used to indicate metal binding by fusing the polypeptides between the FRET pair cyan fluorescence protein (CFP) and enhanced yellow fluorescent protein (EYFP). Fusion protein CFP-BR-EYFP was titrated with up to 5 mM of each metal tested. Upon metal binding, the polypeptide folded into its secondary structure, inducing FRET, characterized by a decrease in the emission of CFP (480 nm) and an increase in the emission of EYFP (530 nm). The FRET E was measured by the excitation of CFP at 420 nm and monitoring the decrease in CFP emission at 480 nm and the increase in EYFP emission at 530 nm. Due to the overlap of EYFP's emission spectra with CFP's, a decrease in the FRET E was observed once the maximum was reached, caused by the increased signal at 480 nm. Metal titration results illustrate the polypeptides had a higher affinity to REEs than calcium, including an order of magnitude higher affinity for lanthanides. The beta roll was specific to calcium and lanthanides and did not bind to transition metals present in REEs feedstocks or commonly found in biological systems.

Referring specifically to FIG. 5B, the individual FRET efficiency curves of ten tested REEs were examined. CFP-BR-EYFP fusion protein was serially titrated with 500 μM of each REE tested. A correlation between the ionic radius of the element and its affinity to the peptide was identified as well. Without wishing to be bound by theory, the apparent disassociation constant k_{d} was quantified by fitting the FRET E curves to a sequential model over the Hill equation for two reasons. First, the Hill equation does not accurately reflect a reaction scheme for a peptide with more than one binding site. Second, independent studies have shown the beta roll to fold the C-terminus first in a sequential fashion, assuming lanthanides binding does not alter the order of complex formation. Calcium-induced folding of the beta roll had an apparent k_{d} of 150 μM, while lanthanide-induced folding had a significantly better affinity with an apparent k_{d} ranging from 15-50 μM. Seven oxygen atoms coordinated each calcium ion in the binding sites of the peptide. The FRET E curves illustrate a gradient in affinity to the REEs, with cerium having the lowest affinity to the protein and ytterbium having the highest.

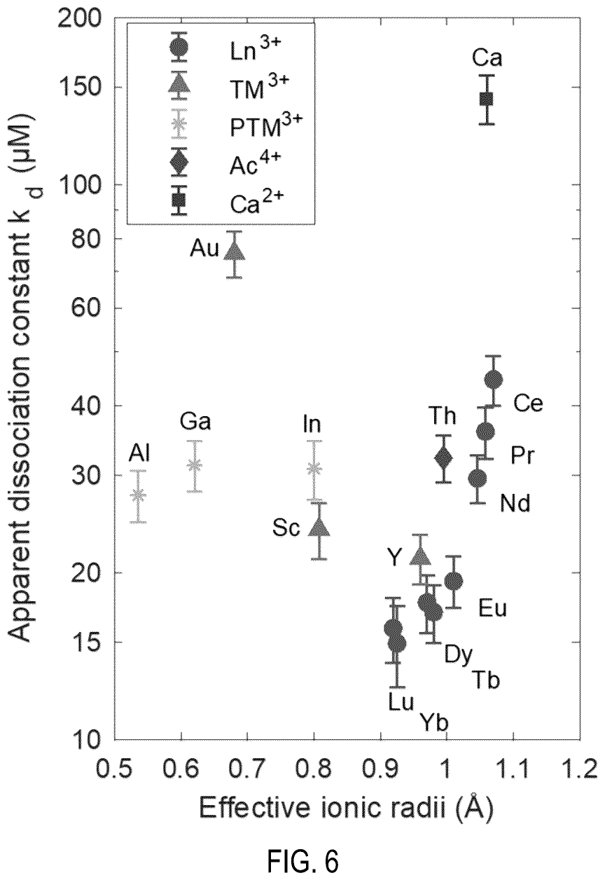

Referring now to FIG. 6, assuming the same coordination geometry for lanthanides, the apparent disassociation constant was plotted versus the effective ionic radii. The BR's affinity to the metals was quantified by fitting the FRET E curves to a sequential model. The apparent disassociation constant k_{d} for lanthanides ranged from 15-50 μM (3-10)-fold better than calcium (150 μM). A parabolic dependence of the apparent k_{d} on the effective ionic radii was observed, with the highest affinity at 0.92 Å (Yb at 0.925 Å). Light REEs, which most closely resemble calcium, had lower binding affinity than heavy REEs. Smaller post-transition metal ions such as aluminum and gallium did not follow the trend, likely inducing a protein structure different from calcium-bound beta roll.

The specificity of the beta roll was tested using the FRET system with up to 5 mM of 33 different metal salts that the peptide would encounter in biological systems or in possible REEs feedstocks. Monovalent cations sodium and lithium did not induce a FRET signal. The binding sites are rich in negatively charged amino acids and partially charged oxygens. Monovalent cations are unlikely to stabilize the repulsion in the binding pocket. Group IIA divalent s-block elements (Mg²⁺, Sr²⁺, and Ba²⁺) share many chemical properties and similarities with calcium. All three cations induced a FRET signal with an apparent k_{d} on the order of mM. The beta roll evolved to distinguish calcium ions from other common ions in biological systems, such as magnesium. Without wishing to be bound by theory, the low affinity of these metals is likely due to strontium and barium having significantly larger ionic radii and magnesium having a considerably smaller ionic radius. Additionally, magnesium prefers a different coordination geometry than calcium's pentagonal-bipyramidal and binding by nitrogen atoms.

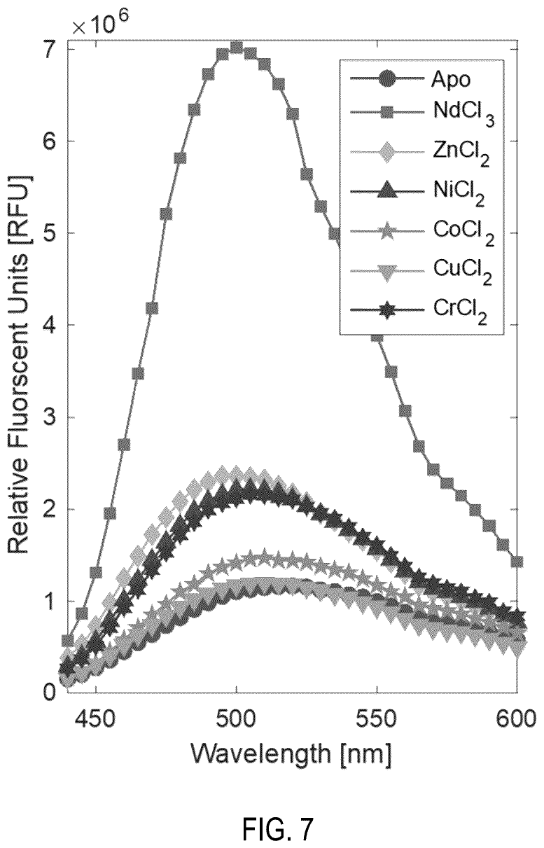

Referring now to FIG. 7, a range of divalent and trivalent transition metals were tested, and they did not promote the folding of the beta roll. Fe²⁺, Cd²⁺, Cr³⁺, V³⁺, and Mo³⁺ did not bind to the beta roll, and FRET was not observed. Unexpectedly, Mn²⁺, Co²⁺, Ni²⁺, Cu²⁺, and Zn²⁺ lead to a linear increase in the FRET signal. However, a His-tag, a short nickel binding peptide, was fused to the CFP-BR-EYFP protein construct to assist in purification. It was believed that the FRET signal observed with these ions was due to the dimerization of the His-tag, as previously reported. To confirm the hypothesis, the metal-induced folding of the beta roll was tested using bis-ANS, which has been shown to produce a significant fluorescence signal (450 nm-600 nm) upon binding to folded beta roll and excitation at 390 nm. Purified beta roll samples (1 μM) were titrated with 1 mM of each metal ion. NdCl₃ was used as a positive control. Co²⁺, Ni²⁺, Cu²⁺, and Zn²⁺ did not stimulate a similar response as Nd³⁺, and thus the observed FRET was concluded to be an artifact of the system.

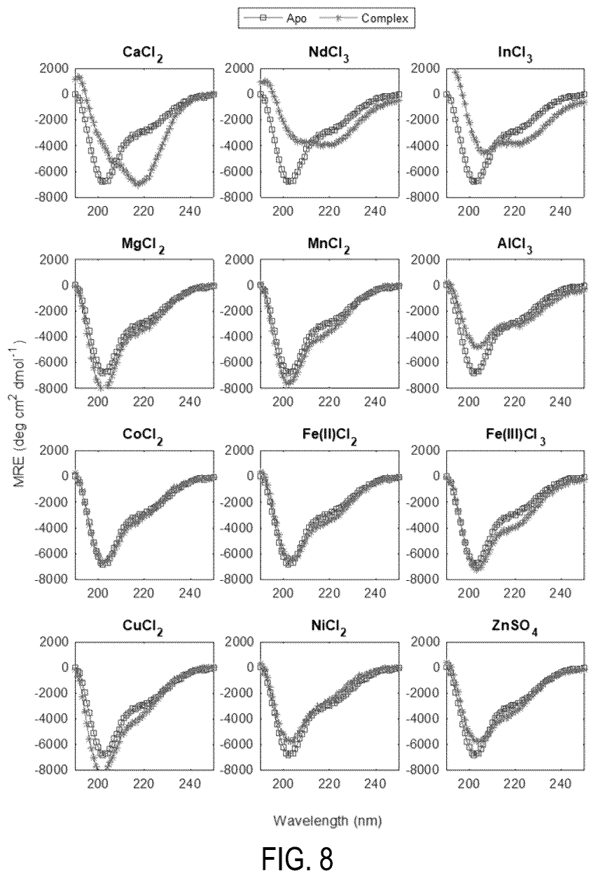

d-block transition metals exist in high concentrations in REEs feedstocks. Referring now to FIG. 8, to ensure the selectivity of the beta roll against these metals, their binding to the peptide was further characterized using circular dichroism (CD). Apo beta roll has a signature CD spectrum with a peak around 200 nm due to its disordered nature. Metal-bound beta roll is characterized by a gain in beta sheets content which is observed as a broad peak between 210-220 nm. Mn²⁺, Co²⁺, Cu²⁺, Fe²⁺, Fe³⁺, Ni²⁺, and Zn²⁺ were tested by titrating the beta roll (55 μM) with 1 mM of each metal. Calcium, neodymium, and indium induced a structural change to the beta roll and induced beta-sheet formation. Aluminum induced an ordered structure with no beta-sheet formation indicating a different binding mechanism or sites than calcium. The beta roll remained disordered in the presence of magnesium and all transition metals. CD spectra analysis using BESTSEL Disordered-Ordered Classification determined all beta roll samples tested disordered in the presence of the ions. The beta roll's ability to omit transition metals from the binding pocket is highly beneficial for the efficient, selective recovery of REEs. The protein evolved a coordination sphere and a binding cavity for calcium ions. Without wishing to be bound by theory, the ionic radii of d-block metals, significantly smaller than calcium, and their preference for an octahedral coordination geometry ground their exclusion from the calcium-binding pockets.

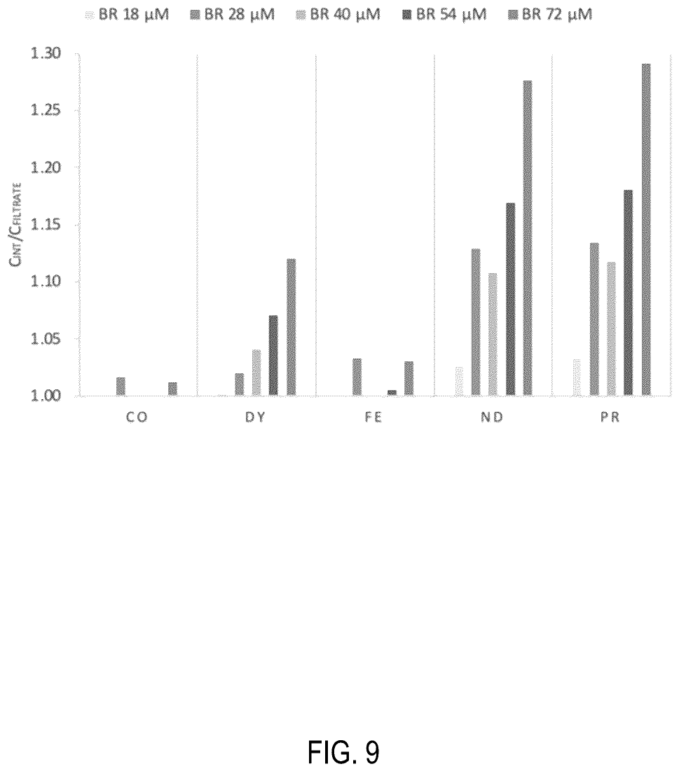

Referring now to FIG. 9, e-wastes were treated with purified RTX polypeptide beta rolls to demonstrate their selectivity for REEs over non-REE metals. NdFeB magnet leachate stimulant solution samples were titrated with increasing concentrations of RTX polypeptide beta rolls. The polypeptides were able to selectively recover REEs (Nd, Dy, Pr) while leaving behind non-REEs (Fe, Co).

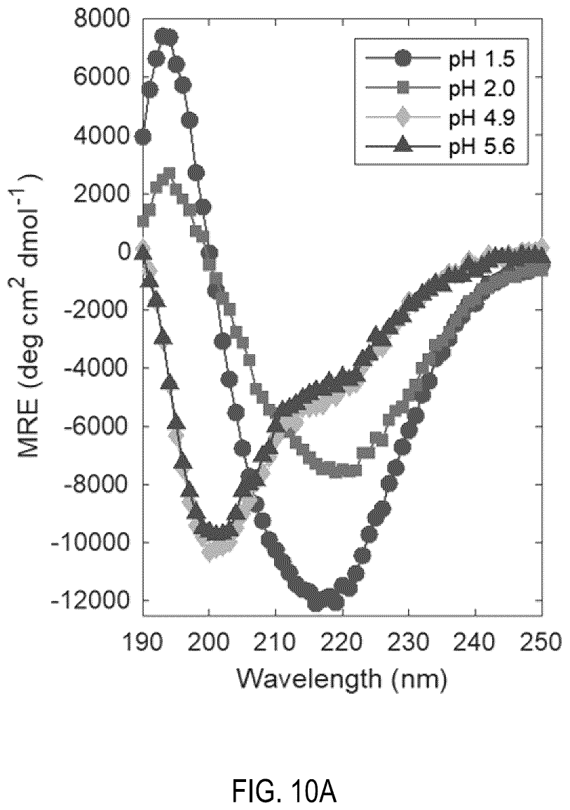

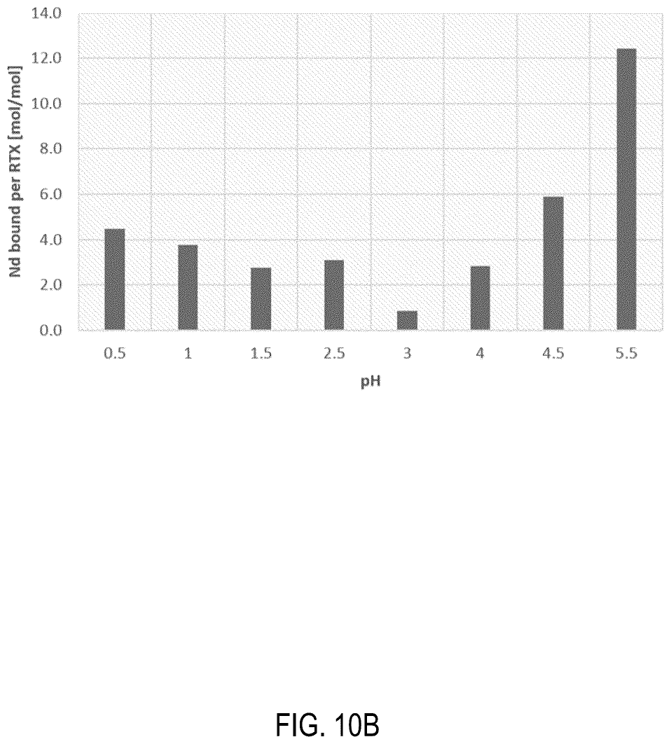

Finally, referring to FIGS. 10A and 10B, the effect of pH on the structure of the beta roll was tested using CD. The naturally disordered protein gained secondary structure as the pH was decreased. The CD spectra of Apo beta roll at varying acidic conditions (FIG. 10A) show a disordered structure at pH 5.6 and 4.9, an ordered intermediate structure at pH 2.0, and a fully folded beta roll at pH 1.5. Thus, the protein can be used for REE capture in ultra-low acidic conditions.

Ultrafiltration assay was used to test the effect of pH on REE capture by the beta roll. 20 μM beta roll samples in 25 mM Glycine, 25 mM potassium acetate, and 50 mM potassium chloride supplemented with 500 μM of NdCl₃, at varying pH, were concentrated using Amicon Ultra-0.5 Centrifugal Filter Unit with a MW cutoff of 3 kDa. Samples were centrifuged at 7,500 g, and the flow-through was collected at intervals of 5 min, 10 min, 20 min, and 30 min. Neodymium concentrations in the retentate and flow-through samples were determined using the Arsenazo III assay. The results (FIG. 10B) demonstrate the beta roll ability to bind up to 4 mol/mol of neodymium at ultra-low pH, the most abundant REE in electronic wastes.

Systems and methods of the present disclosure are advantageous in that they enable a greener and better alternative to conventional processes for the separation of REEs. REEs have been gaining increasing attention with the transformation into a clean energy economy. Native and synthetic RTX/BR domains can be used to bind and recover REEs with enhanced REE selectivity. It appears that the overall affinity of the beta roll for REEs results in a higher binding capacity than lanmodulin, which can only bind three REE ions per protein while the beta roll can bind 9 or more. The beta roll is also advantageous in that it has a modular, repetitive structure and the length of the BR can be extended to have even more REE binding sites per protein.

The beta roll domain represents an avenue for the bioseparation of REEs from primary sources as well as in recycling operations. By way of example, the systems and methods of the present disclosure could be used to extract REEs from electronic wastes such as NdFeB magnets. In some embodiments, the systems and methods of the present disclosure are incorporated into REE sequestration during biomining and bioleaching operations, e.g., via BR-rustacyanin fusion in the biomining microbe A. ferrooxidans. Some embodiments of the present disclosure include BR mutants that can precipitate when binding REEs, and such a system would be valuable for binding and separating REEs from solution. Additional disclosure relevant to the instant disclosure can be found at U.S. Pat. Nos. 9,127,267, 9,550,805, 10,059,934, and 10,358,461, which are incorporated herein by reference in their entireties.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A method of recovering a metal product, comprising:
providing a sample including a metal component;
contacting the sample with a polypeptide including at least a portion of a repeats-in-toxin (RTX) domain; and
binding an amount of the metal component to the polypeptide to form a metal-peptide complex,
wherein the metal component includes rare earth elements (REEs), REE-containing compounds, or combinations thereof.

2. The method according to claim 1, further comprising:
isolating a product including a concentration of metal-peptide complexes from the sample.

3. The method according to claim 1, wherein the metal component includes scandium, yttrium, lanthanum, cerium, praseodymium, neodymium, europium, terbium, dysprosium, ytterbium, indium, lutetium, compounds including one or more of these REEs, or combinations thereof.

4. The method according to claim 1, wherein binding an amount of the metal component to the polypeptide to form a metal-peptide complex includes:
inducing a conformational change in the polypeptide from a disordered conformation to a beta-roll secondary structure.

5. The method according to claim 4, wherein contacting the sample with a polypeptide includes:
dissolving the sample to form a solution including the metal component; and
administering an amount of the polypeptide to the solution.

6. The method according to claim 5, further comprising:
precipitating the metal-peptide complex from the solution.

7. The method according to claim 5, wherein the pH of the solution is below about 3.

8. The method according to claim 7, wherein the pH of the solution is below about 1.5.

9. The method according to claim 1, wherein the polypeptide includes a plurality of oligopeptides, wherein the oligopeptides include the amino acid sequence X₁X₂X₃X₄X₅X₆X₇X₈X₉ (SEQ ID NO: 1), wherein:
X₁ includes glycine, valine, and serine;
X₂ includes glycine, serine, asparagine, or aspartic acid;
X₃ includes alanine, serine, glycine, aspartic acid, glutamic acid, glutamine, tyrosine, leucine, or asparagine;
X₄ includes glycine, arginine, or alanine;
X₅ includes asparagine, aspartic acid, alanine, histidine, or serine;
X₆ includes aspartic acid or asparagine;
X₇ includes threonine, isoleucine, valine, or leucine;
X₈ includes leucine, isoleucine, tyrosine, or phenylalanine; and
X₉ includes tyrosine, isoleucine, leucine, valine, phenylalanine, threonine, asparagine, aspartic acid, lysine, arginine, or serine.

10. The method according to claim 9, wherein the RTX domain is from the adenylate cyclase protein of Bordetella pertussis.

11. The method according to claim 9, wherein the polypeptide includes a plurality of oligopeptide tandem repeats.

12. The method according to claim 1, wherein the sample includes e-wastes, seaweed ash, mining wastes, or combinations thereof.

13. A method of sequestering metals, comprising:
providing a bacteria modified to include one or more exogenous nucleotide sequences encoding a polypeptide, the polypeptide including at least a portion of a repeats-in-toxin (RTX) domain;
expressing the one or more exogenous nucleotide sequences to generate a concentration of polypeptides;
contacting the bacteria with a medium including a metal component; and
binding an amount of the metal component to the polypeptides to form a metal-peptide complex,
wherein the metal component includes rare earth elements (REEs), REE-containing compounds, or combinations thereof.

14. The method according to claim 13, wherein the metal component includes scandium, yttrium, lanthanum, cerium, praseodymium, neodymium, europium, terbium, dysprosium, ytterbium, indium, lutetium, compounds including one or more of these REEs, or combinations thereof.

15. The method according to claim 13, wherein the pH of the medium is below about 1.5.

16. The method according to claim 13, wherein the polypeptide includes a plurality of oligopeptides, wherein the oligopeptides include the amino acid sequence X₁X₂X₃X₄X₅X₆X₇X₈X₉ (SEQ ID NO: 1), wherein:
X₁ includes glycine, valine, and serine;
X₂ includes glycine, serine, asparagine, or aspartic acid;
X₃ includes alanine, serine, glycine, aspartic acid, glutamic acid, glutamine, tyrosine, leucine, or asparagine;
X₄ includes glycine, arginine, or alanine;
X₅ includes asparagine, aspartic acid, alanine, histidine, or serine;
X₆ includes aspartic acid or asparagine;
X₇ includes threonine, isoleucine, valine, or leucine;
X₈ includes leucine, isoleucine, tyrosine, or phenylalanine; and
X₉ includes tyrosine, isoleucine, leucine, valine, phenylalanine, threonine, asparagine, aspartic acid, lysine, arginine, or serine.

17. The method according to claim 16, wherein the RTX domain is from the adenylate cyclase protein of Bordetella pertussis.

18. A method of recovering rare earth elements (REEs), comprising:
providing a solution including a concentration of REEs, REE-containing compounds, or combinations thereof;
contacting the solution with a disordered polypeptide including at least a portion of a repeats-in-toxin (RTX) domain;
binding an amount of the REEs, REE-containing compounds, or combinations thereof to the polypeptide to form a metal-peptide complex having a beta-roll secondary structure; and
isolating a product including a concentration of metal-peptide complexes from the solution.

19. The method according to claim 18, wherein the solution includes dissolved e-wastes, seaweed ash, mining wastes, or combinations thereof.

20. The method according to claim 18, wherein the polypeptide includes a plurality of oligopeptides, wherein the oligopeptides include the amino acid sequence X₁X₂X₃X₄X₅X₆X₇X₈X₉ (SEQ ID NO: 1), wherein:
X₁ includes glycine, valine, and serine;
X₂ includes glycine, serine, asparagine, or aspartic acid;
X₃ includes alanine, serine, glycine, aspartic acid, glutamic acid, glutamine, tyrosine, leucine, or asparagine;
X₄ includes glycine, arginine, or alanine;
X₅ includes asparagine, aspartic acid, alanine, histidine, or serine;
X₆ includes aspartic acid or asparagine;
X₇ includes threonine, isoleucine, valine, or leucine;
X₈ includes leucine, isoleucine, tyrosine, or phenylalanine; and
X₉ includes tyrosine, isoleucine, leucine, valine, phenylalanine, threonine, asparagine, aspartic acid, lysine, arginine, or serine.
